(19) United States
(12) Patent Application Publication
(10) Pub. No.: US 2019/0390051 A1
(43) Pub. Date: Dec. 26, 2019

(54) REDUCTION OF EDGE YELLOWING OF POLYVINYLACETAL LAMINATES

(71) Applicant: KURARAY AMERICA, INC., Houston, TX (US)

(72) Inventor: Donald L. RYMER, Houston, TX (US)

(73) Assignee: KURARAY AMERICA, INC., Houston, TX (US)

(21) Appl. No.: 16/444,335

(22) Filed: Jun. 18, 2019

Related U.S. Application Data
(60) Provisional application No. 62/688,717, filed on Jun. 22, 2018.

(51) Int. Cl. C08L 29/14; C08J 5/18; C08J 3/22; B32B 27/30; B32B 27/22

(52) U.S. Cl. CPC C08L 29/14; C08J 5/18; C08J 3/226; B32B 27/306; C08L 2310/00; C08J 2329/14; C08J 2367/02; C08L 2205/06; C08L 2201/08; B32B 27/22

(57) ABSTRACT

Provided herein are polyvinylacetal compositions, monolayer and multilayer films and sheets (interlayers), and laminates made with these interlayers, which have reduced edge yellowing after exposure to heat, which is accomplished by adding an oligomeric hindered amine light stabilizer with antioxidant functionality at levels generally about 0.2 percent by weight or less, wherein substantially no additional antioxidant or other HALS is present.

### CROSS-REFERENCE TO RELATED APPLICATIONS

This application claims priority under 35 U.S.C. § 119 from U.S. Provisional Application Ser. No. 62/688,717 (filed 22 Jun. 2018), the disclosure of which is incorporated by reference herein for all purposes as if fully set forth.

### FIELD OF THE INVENTION

The present invention relates to polyvinylacetal compositions, monolayer and multilayer films and sheets, and laminates made with these films/sheets, which exhibit reduced edge yellowing after exposure to heat.

### BACKGROUND OF THE INVENTION

Plasticized polyvinylacetal, and particularly polyvinybutyral (PVB), is used in interlayers for the manufacture of laminate structures such as, for example: windshields for vehicles including automobiles, motorcycles, boats and airplanes; homes and buildings; shelving in cabinets and display cases; and other articles where structural strength is desirable in a glass sheet.

The plasticized polyvinylacetals exhibit yellowing when exposed to heat or air over time. The use of a light stabilizing/antioxidant additive package of hindered amine light stabilizers (HALS) along with separate antioxidants is commonplace, for example, to give better edge stability (i.e., lower edge yellowing). This has been disclosed in US2016/0214354A1, US2016/0214352A1, US2017/0253704A1, US2017/0072665A1 and US2017/0217132A1.

Processes to produce plasticized polyvinylacetal resin and interlayers are in a general sense known as described, for example, in U.S. Pat. No. 8,329,793B2.

The ability to decrease the yellowness of the plasticized polyvinylacetal materials is desirable. The increased yellowness can arise in extrusion processing within commonly used polymer processing temperatures, as well as exposure of the laminates or melt to air. The achievement of acceptable levels of yellowness (i.e., low yellowness indices (YI) and low delta E) is critical to improved products.

### SUMMARY OF THE INVENTION

In one aspect of the invention, a plasticized polyvinylacetal composition is provided, wherein the composition comprises (a) a polyvinylacetal resin having a hydroxyl number of from about 12 to about 34; (b) a plasticizer in an amount of about 60 parts per hundred (pph) or less based on the dry weight of the polyvinylacetal resin; and (c) a light stabilizer/antioxidant additive package comprising an oligomeric hindered amine light stabilizer with antioxidant functionality (“oligomeric HALS”), wherein substantially no additional antioxidant or hindered amine light stabilizer is present in the plasticized polyvinylacetal composition.

In one embodiment, the plasticized polyvinylacetal composition is a plasticized polyvinylbutyral composition.

In another embodiment, the oligomeric HALS is present in the plasticized polyvinylacetal composition in an amount of from about 0.03 to about 0.2 weight percent based on the total weight of the composition.

In another embodiment, the oligomeric HALS is butanedioic acid, dimethylester, polymer with 4-hydroxy-2,2,6,6,-tetramethyl-1-piperidine ethanol.

In another embodiment, the composition further comprises one or more surfactants in a combined amount of from about 0.01 to about 0.85 pph based on the dry weight of the polyvinylacetal resin.

In another embodiment, the composition contains a light stabilizer/antioxidant additive package consisting essentially of an oligomeric HALS and optionally a UV absorber, or consisting of an oligomeric HALS and optionally a UV absorber.

In another embodiment, the composition further comprises an adhesion control agent. In another embodiment, the adhesion control agent is one or more alkali metal salts and/or alkaline earth metal salts. In another embodiment, the adhesion control agents is a potassium salt, a magnesium salt or a mixture thereof. In another embodiment, the adhesion control agent is a magnesium salt. In another embodiment, the adhesion control agent is a mixture of a predominant amount of a magnesium salt with a minor amount of a potassium salt (on a metal equivalent basis).

In another embodiment, the adhesion modifier is present in an amount such that the adhesive force of the resulting laminate to a glass is adjusted to about 3 or more and about 10 or less in a pummel test as described in US2005/0256258A1.

Further provided is a monolayer film or sheet (monolayer interlayer) comprising the plasticized polyvinylacetal composition.

Further provided is a multilayer (two or more layers) sheet (multilayer interlayer) comprising at least one layer of the above monolayer film or sheet.

Laminates comprising such interlayers are also provided as an aspect of the present invention. In one embodiment, such laminates show a decrease in yellowness, generally greater than about 4 percent delta E, and are discussed in further detail below.

### DETAILED DESCRIPTION

The present invention relates to a polyvinylacetal resin composition, a film or sheet (interlayer) made from such resin composition, and laminates made from such interlayers.

The following definitions apply to the terms as used throughout this specification, unless otherwise limited in specific instances.

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the specification, including definitions, will control.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The transitional phrase “consisting of” or “consists of” excludes any element, step, or ingredient not specified in the claim, closing the claim to the inclusion of materials other than those recited except for impurities ordinarily associated therewith. When the phrase “consisting of” or “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a ‘consisting of’ format and fully open claims that are drafted in a “comprising” format. Optional additives as defined herein, at levels that are appropriate for such additives, and minor impurities are not excluded from a composition by the term “consisting essentially of”.

When a composition, a process, a structure, or a portion of a composition, a process, or a structure, is described herein using an open-ended term such as “comprising,” unless otherwise stated the description also includes an embodiment that “consists essentially of” or “consists of” the elements of the composition, the process, the structure, or the portion of the composition, the process, or the structure.

The term “substantially free”, or “substantially no additional” as used herein with respect to a composition and a component, refers to a composition that includes no more than an adventitious amount of the component, such as an amount that would be present at a contaminant level. Stated alternatively, the composition includes substantially no (or no) added amount of the component, only the amount that is commonly present in the raw materials from which the composition is produced. In some commercially available materials, the level of adventitious components is less than about 0.5%, or less than about 0.1%, or less than about 0.05%, or less than about 0.01% by weight, based on the weight of the commercially available material.

The term “film” means a monolayer or multilayer structure which in and of itself does not provide the penetration resistance necessary to use it as an interlayer in a glass laminate. “Necessary penetration resistance” refers to the minimum penetration resistance for laminated glass as defined in accordance with 49 C.F.R. Section 571.205 and ANSI Z26.1-1996, as would be recognized by one of ordinary skill in the relevant art.

The term “sheet” means a monolayer or multilayer structure that in and of itself provides the necessary penetration resistance for laminated glass as discussed above. For clarification, a multilayer sheet may be comprised of one or more films and/or single layer sheets so long as the multilayer sheet meets the penetration resistance criteria.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

The term “or”, as used herein, in inclusive; that is, the phrase “A or B” means “A, B, or both A and B”. More specifically, a condition “A or B” is satisfied by any one of the following: A is true (or present) and B is false (or not present); A is false (or not present), and B is true (or present); or both A and B are true (or present). Exclusive “or” is designated herein by terms such as “either A or B” and “one of A or B”, for example.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. The scope of the invention is not limited to the specific values recited when defining a range.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

Unless stated otherwise, all percentages, parts, ratios and like amounts, are defined by weight.

Although methods and materials similar or equivalent to those described herein can be used in the practice or testing of the present disclosure, suitable methods and materials are described herein. The materials, methods, and examples herein are thus illustrative only and, except as specifically stated, are not intended to be limiting.

Provided herein is a plasticized polyvinylacetal composition, preferably a polyvinylbutyral composition, wherein the composition comprises (a) a polyvinylacetal resin having a hydroxyl number of from about 12 to about 34, preferably of from about 15 to about 34, as determined according to ASTM D1396-92; (b) a plasticizer in an amount of about 60 parts per hundred (pph) or less, based on the dry weight of the polyvinylacetal resin; and (c) a light stabilizer/antioxidant additive package comprising an oligomeric hindered amine light stabilizer with antioxidant functionality (HALS); wherein substantially no additional antioxidant or hindered amine light stabilizer is present. It is further provided that the plasticized polyvinylacetal composition is a plasticized polyvinylbutyral composition. Additionally, films and sheets comprising the plasticized polyvinylacetal composition, as well as laminates comprising said filams and sheets, are provided herein.

Polyvinylacetal Resin

Suitable polyvinylacetal resins and processes for their preparation are in a general sense well known to those of ordinary skill in the relevant art, as exemplified by previously incorporated U.S. Pat. No. 8,329,793B2, US2016/0214354A1, US2016/0214352A1, US2017/0253704A1, US2017/0072665A1 and US2017/0217132A1, and other publications mentioned below. These resins show, for example, acceptable impact strength per end-use standards, acceptable adhesion, low color, low haze, and relatively little change in end-use conditions.

The polyvinylacetal resin can be produced by conventionally known methods of acetalization of polyvinyl alcohol with an aldehyde. The polyvinyl alcohol is produced by hydrolysis of a corresponding polyvinyl acetate.

A viscosity average polymerization degree of polyvinyl alcohol serving as a raw material of the polyvinylacetal resin is typically 100 or more, or 300 or more, or 400 or more, or 600 or more, or 700 or more, or 750 or more, or 900 or more, or 1200 or more. When the viscosity average polymerization degree of polyvinyl alcohol is too low, there is a concern that the penetration resistance or creep resistance properties, particularly creep resistance properties under high-temperature and high-humidity conditions, such as those at 85° C. and at 85% RH, are lowered. In addition, the viscosity average polymerization degree of polyvinyl alcohol is typically 5000 or less, or 3000 or less, or 2500 or less, or 2300 or less, or 2000 or less. When the viscosity average polymerization degree of polyvinyl alcohol is more than 5000, there is a concern that the extrusion of a resin film is difficult. Viscosity average degree of polymerization is measured in accordance with JIS K6726 (1994).

It is to be noted that since the viscosity average polymerization degree of the polyvinylacetal resin coincides with the viscosity average polymerization degree of polyvinyl alcohol serving as a raw material, the above-described preferred viscosity average polymerization degree of polyvinyl alcohol coincides with the typical viscosity average polymerization degree of the polyvinylacetal resin.

The polyvinylacetal resin is generally constituted of vinyl acetal units, vinyl alcohol units and vinyl acetate units, and these respective units can be, for example, measured by the “Testing Methods for Polyvinyl Butyral” of JIS K 6728, or a nuclear magnetic resonance method (NMR).

Typically, a polyvinylacetal resin is used having a hydroxyl number of from about 12 to about 34, preferably of from about 15 to about 34 (as determined according to ASTM D1396-92).

In the case where the polyvinylacetal resin contains a unit other than the vinyl acetal unit, by measuring a unit quantity of vinyl alcohol and a unit quantity of vinyl acetate and subtracting these both unit quantities from a vinyl acetal unit quantity in the case of not containing a unit other than the vinyl acetal unit, the remaining vinyl acetal unit quantity can be calculated.

The aldehyde which is used for acetalization of polyvinyl alcohol is preferably an aldehyde having 1 or more and 12 or less carbon atoms. When the carbon number of the aldehyde is more than 12, the reactivity of the acetalization is lowered, and moreover, blocking of the resin is liable to be generated during the reaction, and the synthesis of the polyvinyl acetal resin is liable to be accompanied with difficulties.

The aldehyde is not particularly limited, and examples thereof include aliphatic, aromatic, or alicyclic aldehydes, such as formaldehyde, acetaldehyde, propionaldehyde, n-butyl aldehyde, isobutyl aldehyde, valeraldehyde, n-hexyl aldehyde, 2-ethylbutyl aldehyde, n-heptyl aldehyde, n-octyl aldehyde, n-nonyl aldehyde, n-decyl aldehyde, benzaldehyde, cinnamaldehyde, etc. Of those, aliphatic aldehydes having 2 or more and 6 or less carbon atoms are preferred, and above all, butyl aldehyde is especially preferred. In addition, the above-described aldehydes may be used solely or may be used in combination of two or more thereof. Furthermore, a small amount of a polyfunctional aldehyde or an aldehyde having other functional group, or the like may also be used in combination in an amount in the range of 20% by mass or less.

The polyvinylacetal resin is most preferably polyvinyl butyral.

Plasticizers

The polyvinylacetal resin compositions of the present invention contain a plasticizer. Suitable plasticizers can be chosen from any that are known or used conventionally in the manufacture of plasticized PVB sheeting compositions. For example, a plasticizer suitable for use herein can be a plasticizer or a mixture of plasticizers selected from the group consisting of: diesters obtained from the chemical reaction of aliphatic diols with carboxylic acids, including diesters of polyether diols or polyether polyols; and, esters obtained from polyvalent carboxylic acids and aliphatic alcohols. For convenience, when describing the sheet compositions of the present invention, a mixture of plasticizers can be referred to herein as “plasticizer”. That is, the singular form of the word “plasticizer” as used herein can represent the use of either one plasticizer or the use of a mixture of two or more plasticizers in a given sheet composition. The intended use will be apparent to a reader skilled in the art. Preferred plasticizers for use herein are diesters obtained by the reaction of triethylene glycol or tetraethylene glycol with aliphatic carboxylic acids having from 6 to 10 carbon atoms; and diesters obtained from the reaction of sebacic acid with aliphatic alcohols having from 1 to 18 carbon atoms. More preferably the plasticizer is either tetraethylene glycol di(2-heptanoate) (4G7), triethyleneglycol di-(2-ethyl hexanoate) (3GO), dihexyl adipate (DHA), triethylene glycol di(2-ethylbutyrate (3GH), dibutyl sebacate (DBS) or mixtures thereof. Most preferably the plasticizer is 3GO.

Plasticizer content (total) of the polvinylacetal compositions is typically about 60 pph or less, or about 50 pph or less, based on the dry weight of the polyvinylacetal resin. The lower limit of the plasticizer will be sufficient so that the polyvinylacetal composition can be extruded into a film or sheet under reasonable commercial conditions, which will be recognized by one of ordinary skill in the relevant art. Typically, a lower limit of plasticizer content is about 20 pph or more, or about 30 pph or more, based on the dry weight of the polyvinylacetal resin.

These plasticizer amounts are as added into the polyvinylacetal composition (before extrusion into a film or sheet).

It should be noted in multilayer interlayers the plasticizer may migrate from one layer to another to an equilibrium point at a certain set of environmental conditions (mainly temperature). At such equilibrium conditions, the plasticizer content of any given layer in a multilayer interlayer may fall within or outside the above stated values.

Optional Additives

The polyvinylacetal compositions of the present invention may optionally include a surfactant. A surfactant suitable for use herein can be any that is known to be useful in the art of polyvinylacetal manufacture. For example, surfactants suitable for use herein include: sodium lauryl sulfate; ammonium lauryl sulfate; sodium dioctyl sulfosuccinate; ammonium perfluorocarboxylates having from 6 to 12 carbon atoms; sodium aryl sulfonates, adducts of chlorinated cyclopentadiene and maleic anhydride; partially neutralized polymethacrylic acid; alkylaryl sulfonates; sodium N-oleyl-N-methyl taurate; sodium alkylaryl polyether sulfonates; triethanolamine lauryl sulfate; diethyl dicyclohexyl ammonium lauryl sulfate; sodium secondary-alkyl sulfates; sulfated fatty acid esters; sulfated aryl alcohols; and the like. Preferable surfactants include sodium lauryl sulfate, sodium dioctyl sulfocuccinate, sodium cocomethyl tauride, and decyl(sulfophenoxy)benzenesulfonic acid disodium salt. It has been found that sodium docecyl sulfate (SDS) and sodium lauryl sulfate (SLS) are particularly useful.

The surfactant can be included in any effective amount for the particular set of process conditions practiced. The surfactant can be included in an amount of from about 0.01, or from about 0.10, or from about 0.15, to about 0.85, or to about 0.80, or to about 0.75, or to about 0.70, pph by weight, based on the weight of polyvinylacetate resin ultimately used to prepare the polyvinylacetal resin.

In addition, it is also possible to control the adhesion of the resulting laminate to a glass or the like, if desired, through the addition of one or more adhesion modifier.

Typical adhesion modifiers include, for example, alkali metal and/or alkaline earth metal salts such as those disclosed in US2005/0256258A1. Examples of suitable alkali metal salts and alkaline earth metal salts include salts of potassium, sodium, magnesium, and the like, including mixtures thereof. Examples of the salt include salts of organic acids, such as neodecanoic acid, octanoic acid, hexanoic acid, butyric acid, acetic acid and formic acid; inorganic acids, such as hydrochloric acid and nitric acid; and the like. Magnesium compounds are preferred. Mixtures of a predominant amount of a magnesium compound with a minor amount of a potassium compound (on a metal equivalent basis) are also preferred. Typical amounts of salt adhesion modifiers range (cumulative) from about 0.001 wt %, or from about 0.005 wt %, or from about 0.01 wt %, to about 0.25 wt %, or to about 0.1 wt %, based on the total weight of the polyvinylacetal composition.

Silanes such as disclosed in US20100108125A1 and US20110105681A1 may also be used as adhesion modifiers.

Reactive functional group-containing olefinic polymers wherein the functional group is at least one group selected from a carboxyl group and a derivative group of a carboxyl group (herein below, referred to as a carboxylic group-containing olefinic polymer) can also be used as adhesion modifiers. Suitable carboxylic group-containing olefinic polymers are disclosed, for example, in U.S. Pat. No. 7,989,083B2.

Though an optimal addition amount of the adhesion modifier varies with the additive to be used and the resin to be adhesion modified, it is preferably adjusted in such a manner that an adhesive force of the resulting laminate to a glass is generally adjusted to about 3 or more and about 10 or less in a pummel test (described in US2005/0256258A1 or the like). In particular, in the case where high penetration resistance is required, the addition amount of the adhesion modifier is more preferably adjusted in such a manner that the adhesive force is about 3 or more and about 6 or less, whereas in the case where high glass scattering preventing properties are required, the addition amount of the adhesion modifier is more preferably adjusted in such a manner that the adhesive force is about 7 or more and about 10 or less.

Heat shielding additives may also be utilized. When a laminated glass is prepared by incorporating a heat-shielding fine particle or a heat-shielding compound as the heat-shielding material into the interlayer of the present invention to give a heat-shielding function to the laminate, a transmittance at a wavelength of 1,500 nm can be regulated to about 50% or less, or the TDS value (calculated from ISO 13837:2008) can be regulated to less than about 43%. In a multilayer interlayer, the heat-shielding material may be contained in any one or combination of the layers.

Examples of the heat-shielding fine particle include a metal-doped indium oxide, such as tin-doped indium oxide (ITO), a metal-doped tin oxide, such as antimony-doped tin oxide (ATO), a metal-doped zinc oxide, such as aluminum-doped zinc oxide (AZO), a metal element composite tungsten oxide represented by a general formula: MₘWOₙ (M represents a metal element; m is about 0.01 or more and about 1.0 or less; and n is about 2.2 or more and about 3.0 or less), zinc antimonate (ZnSb₂O₅), lanthanum hexaboride, and the like. Of those, ITO, ATO, and a metal element composite tungsten oxide are preferred, and a metal element composite tungsten oxide is more preferred. Examples of the metal element represented by M in the metal element composite tungsten oxide include Cs, Tl, Rb, Na, K, and the like, and in particular, Cs is preferred. From the viewpoint of heat shielding properties, m is preferably about 0.2 or more, or about 0.3 or more, and it is preferably about 0.5 or less, or about 0.4 or less.

A content of the heat shielding fine particle is preferably about 0.01% by mass or more, or about 0.05% by mass or more, or about 0.1% by mass or more, or about 0.2% by mass or more relative to the whole of the resins used for the layers constituting the interlayer. In addition, the content of the heat shielding fine particle is preferably about 5% by mass or less, or about 3% by mass or less.

From the viewpoint of transparency of the laminate, an average particle diameter of the heat shielding fine particle is preferably about 100 nm or less, or about 50 nm or less. It is to be noted that the average particle diameter of the heat shielding particle as referred to herein means one measured by a laser diffraction instrument.

Examples of heat shielding compounds include phthalocyanine compounds, naphthalocyanine compounds, and the like. From the viewpoint of further improving the heat shielding properties, it is preferred that the heat shielding compound contains a metal. Examples of the metal include Na, K, Li, Cu, Zn, Fe, Co, Ni, Ru, Rh, Pd, Pt, Mn, Sn, V, Ca, Al, and the like, with Ni being especially preferred.

A content of the heat shielding compound is preferably about 0.001% by mass or more, or about 0.005% by mass or more, or about 0.01% by mass or more relative to the whole of the resins used for the layers constituting the laminate. In addition, the content of the heat shielding compound is preferably about 1% by mass or less, or about 0.5% by mass or less.

Utraviolet ray absorbers (“UV absorbers”) may also be used. Examples include benzotriazole-based ultraviolet ray absorbers, such as 2-(5-methyl-2-hydroxyphenyl)benzotriazole, 2-[2-hydroxy-3,5-bis(α,α′-dimethylbenzyl)phenyl]-2H-benzotriazole, 2-(3,5-di-t-butyl-2-hydroxyphenyl)benzotriazole, 2-(3-t-butyl-5-methyl-2-hydroxyphenyl)-5-chlorobenzotriazole, 2-(3,5-di-t-butyl-5-methyl-2-hydroxyphenyl)-5-chlorobenzotriazole and 2-(3,5-di-t-amyl-2-hydroxyphenyl)benzotriazole, 2-(2′-hydroxy-5′-t-octylphenyl)triazole; hindered amine-based ultraviolet ray absorbers, such as 2,2,6,6-tetramethyl-4-piperidyl benzoate, bis(2,2,6,6-tetramethyl-4-piperidyl)sebacate, bis(1,2,2,6,6-pentamethyl-4-piperidyl)-2-(3,5-di-t-butyl-4-hydroxybenzyl)-2-n-butylmalonate and 4-(3-(3,5-di-t-butyl-4-hydroxyphenyl)propionyloxy)-1-(2-(3-(3,5-di-t-butyl-4-hydroxyphenyl)propionyloxy)ethyl)-2,2,6,6-tetramethylpiperidine; benzoate-based ultraviolet ray absorbers, such as 2,4-di-t-butylphenyl-3,5-di-t-butyl-4-hydroxybenzoate and hexadecyl-3,5-di-t-butyl-4-hydroxybenzoate; and the like.

These UV absorbers can be used solely or in combination of two or more thereof. The amount of ultraviolet ray absorber utilized is typically about 10 ppm or more, or about 100 ppm or more, on the basis of a mass relative to the polyvinylacetal resin in the composition. In addition, the amount of UV absorber utilized is typically about 50,000 ppm or less, or about 10,000 ppm or less, on the basis of a mass relative to the polyvinylacetal resin in the composition.

In some embodiments, it is also possible to use two or more types of UV absorbers in combination.

In other embodiments, no UV absorber is added, or the laminate is substantially UV absorber additive free.

In addition to the above, other conventional additives (excluding antioxidants and other HALS) may be used in the polyvinylacetal resin compositions of the present invention, as would be recognized by those of ordinary skill in the relevant art.

Light Stabilizer/Antioxidant Additive Package

Antioxidants are typically used in polyvinylacetal materials, and particularly polyvinylbutyral materials. Often, hindered amine light stabilizers (HALS) have been added as part of a light stabilizer/antioxidant additive package to supplement the antioxidant to reduce yellowing, and have been shown to be of variable effectiveness in preventing yellowing of the materials in which they are used. It has been found that during processing and during exposure while in use, polyvinylacetal films and sheets, and the laminate structures comprising the films and sheets, which are made with previously described HALS and antioxidants combinations, and with previously used processes, may exhibit increases in yellowness, as determined by the as-measured delta E, measured as described herein.

It is preferred that this increase in yellowness is as low as possible, so the appearance of the laminates is not compromised. The yellowness is generally most noticeable at the edges of the laminates. The amount of edge yellowing has generally been found to be dependent on the process heat history of the film. Samples produced with lower hold-up time at temperature yellowed less than those exposed to shorter hold-up times and lower temperatures. However, production penalties can occur when the process is slowed down or run at lower temperatures. Additionally, lower yellowness is noted when oxygen is at least partially excluded from the process.

As indicated previously, a light stabilizer/antioxidant additive package containing separate antioxidants and hindered amine light stabilizers (HALS) is typically used to protect the polymer from air degradation, which is the primary mechanism for edge yellowing. Commonly-used HALS include, but are not limited to Tinuvin®123 (BASF Corporation); Chimassorb®81, 119, 944 and 2020 (BASF Corporation); Tinuvin® 783 (BASF Corporation); and Tinuvin® 111 (BASF Corporation). Typical antioxidants used in conjunction with the HALS include, for example, Lowinox® 44B25, BHT (Chempoint Corporation) or Songnox®2450 (Songwon International AG). However, it has been noted that using certain HALS with or without antioxidant(s) produces higher levels of yellowing in the polymeric sheets. Thermal and oxidative attack on polyvinylacetal films has been reported in many references. See, for example, “Degradation of PVB and its Stabilization by Bases” Volume 93 April 2008 pages 846-853, Elsevier; “PVB Sheet Recycling and Degradation, Michael Tupy, Dagmar Mefinski and Vera KasParkov, cdn.intechopen.com/pdfs/32564/InTech, Mar. 16, 2012; Mechanism of Degradation of Poly(vinyl butyral) using Thermogravimetry/Fourier Transform Infrared Spectrometry, LCK Liau et al., Polymer Engineering and Science 1996, Wiley Online Library, ISSN:1548-2634; Polymer Degradation and Stability 93(2008) pages 846-853, Elsevier Applied Science; and Polymer Degradation and Stability 47(1995) pages 283-288, Elsevier Applied Science.

Therefore, the use or change of additives to improve edge discoloration was explored extensively, with a primary focus on finding a better light stabilizer system.

Antioxidants that were considered included Songnox® 2450 (Songwon International AG), Irganox® 1076 (BASF Corpoation), Irganox® 245 (BASF Corporation) and BHT (Millipore Sigma).

In the present invention, it has been found that oligomeric hindered amine light stabilizers with antioxidant functionality were particularly effective over antioxidants alone or in combination with separate HALS.

One such oligomeric HALS is butanedioic acid, dimethylester, polymer with 4-hydroxy-2,2,6,6,-tetramethyl-1-piperidine ethanol (CAS No. 65447-77-0), available from BASF Corporation as Tinuvin® 622 or from Rianlon Corporation as Thanox® 622. Having an Mn molecular weight of 3100-4000, it has a structure represented as

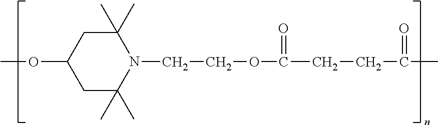

As stated in the product description literature available from the supplier, this oligomeric material is thought to be particularly effective when used in combination with other UV absorbers or antioxidants (particularly other HALS, including but not limited to Chimassorb® materials, Tinuvin® 783 and Tinuvin® 111, all from BASF Corporation), exhibiting synergistic effects. However, in the present invention, and as shown in the following examples, the edge yellowness of the laminate samples was reduced more when the oligomeric material (Tinuvin® 622) was used in polyvinylacetal compositions substantially free of any other separate antioxidants or separate HALS.

The amount of oligomeric HALS in the present polyvinylacetal composition is generally from about 0.03, or from about 0.05, to about 0.2, or to about 0.15, weight percent based on the total weight of the polyvinylacetal composition

Visually, yellowness is associated with scorching, soiling and general product degradation by light, chemical exposure, and processing. As stated above, yellowness is generally measured via delta E, but can also be measured via a yellowness index. Yellowness indices are used chiefly to quantify these types of degradation with a single value. They can be used when measuring clear, near-colorless liquids or solids in transmission and near-white, opaque solids in reflectance. The Yellowness Index (YI) is defined and can be measured as described in ASTM E313-15e1. Likewise, appearance can be affected by haze. This can be measured by methods described in ASTM D1003-13.

In the present invention, yellowness is measured at the edge of the laminate as well as in the center. By “edge of the laminate” is meant 10 mm from the edge of the laminate itself. By “center” is meant approximately equidistant from all edges.

Preparation of Sheets (Interlayers)

Films and sheets (interlayers) of polyvinylacetal compositions of the present invention can be prepared by conventional melt extrusion or melt molding processes suitable for making interlayers for glass laminates. Such processes are well-known to those of ordinary skill in the relevant art, as exemplified by the previously incorporated publications. These processes can employ different ways to cool the melt (water cooled or not water cooled (dry line process)), and various sizes of dies and wind-ups can be used. While the method of control of the moisture level can differ from process to process, the desired moisture level can be achieved with whatever method is chosen. Smaller, semi-works processes generally do not use recycle (non-virgin) material, and commercial dry line processes may or may not use recycle material. However, as those skilled in the art will realize, the end product of whatever process is used can be achieved by adjusting the process parameters accordingly. See, for example, U.S. Pat. No. 5,886,075A.

The sheets may be monolayer or multilayer. The production of multilayer films is described in, for example, US2014/0224423A1 and US 2017/0217132A1. For example, multilayer sheets can be formed having a functional core layer (for example, acoustic dampening) sandwiched between two exterior layers and other optional interior layers.

Laminates

It is possible to produce laminates of the present invention by conventionally known methods. Examples thereof include using a vacuum laminator, using a vacuum bag, using a vacuum ring, using a nip roll, and the like. In addition, a method can be used in which, after temporary contact bonding, the resultant laminate is put into an autoclave for final bonding. Further description of these methods can be found in, for example, U.S. Pat. No. 7,642,307B2.

Advantageously, the glass to be used for preparing a laminated glass is not particularly limited. Inorganic glasses, such as a float sheet glass, a polished sheet glass, a figured glass, heat and chemically-strengthened glass, a wired sheet glass, a heat-ray absorbing glass, and conventionally known organic glasses, such as polymethyl methacrylate and polycarbonate, and the like, can be used. These glasses may be any of colorless, colored, transparent, or non-transparent glasses. These glasses may be used solely, or may be used in combination of two or more thereof. Suppliers of such glass include but are not limited to PPG, Inc., Corning and St. Gobain.

The laminated glass of the present invention can be suitably used for a windshield for automobile, a side glass for automobile, a sunroof for automobile, a rear glass for automobile, or a glass for heads-up display; a building member for a window, a wall, a roof, a sunroof, a sound insulating wall, a display window, a balcony, a handrail wall, or the like; a partition glass member of a conference room; a solar panel; and the like. Further information on such uses can be found by reference to the previously incorporated publications.

The invention will be further understood from the following specific examples of the properties of the resin materials, the sheets of said resin materials, and glass laminates comprising said sheets. However, it will be understood that these examples are not to be construed as limiting the scope of the present invention in any manner.

### EXAMPLES

To gain an assessment of long term UV exposure, the resin composition was produced in a semiworks production facility where an oligomeric HALS was used in place of an antioxidant and/or an antioxidant/HALS combination.

As shown in the examples below, when the samples were exposed for over 600K (5 years natural) Langleys exposure, the Tinuvin® 622 composition was equivalent or better than the currently-used antioxidant (Lowinox® 44B25) and/or HALS (Tinuvin® 123) as measured by change in delta E. This material was also exposed to one- and two-year natural weathering in Florida, using ASTM G7-05 and G147-02, with consistent results.

In order to quantify the optimum amount of Tinuvin® 622 relative to the amount of Lowinox® 44B25 and Tinuvin® 123, experiments were run and are described in the Examples below. As described herein, the experiments were run with a standard adhesion control system comprising potassium and magnesium, as well as one that, instead, comprised only magnesium. An assessment of the data provided herein by ANOVA analysis showed that the lowest edge discoloration was with samples containing substantially no added Tinuvin® 123, no added Lowinox® 44B25, and lower levels of potassium in the adhesion control package. Additionally, lower edge discoloration was obtained when higher levels of magnesium were used for adhesion control.

Materials

Multiple tote bins of multiple lots of polyvinylbutyral flake were acquired from Kuraray America, Inc. (Houston, Tex. USA), and were made as described by their standard operating conditions as described in U.S. Pat. No. 8,329,793B2. The resin had an average OH content of 18.8%, and was dried to a moisture content of less than 2 wt %.

Lowinox® 44B25 antioxidant was used as supplied from Chempoint Corporation (Bellevue, Wash. USA). Tinuvin® 123 hindered amine light stabilizer and Tinuvin® 326 UV absorber were used as supplied by BASF Corporation (Florham Park, N.J. USA). Potassium acetate was used as supplied by J. T. Baker Company (Phillipsburg, N.J. USA), and magnesium acetate was used as supplied from Shepherd Chemical Company (Norwood, Ohio USA).

Tinuvin® 622 oligomeric hindered amine light stabilizer (with antioxidant functionality) was used as supplied by BASF Corporation (Florham Park, N.J. USA), and its generic equivalent, Thanox®622, was used as supplied by Rianlon Corporation (Tianjin, China).

Triethylene glycol glycol bis(2-ethylhexanoate) plasticizer (3GO) was used as supplied from Eastman Chemical Co.

Additive Preparation Procedure

The following additive preparation procedure was used for the samples in the examples below. Processes to make the materials described herein are very similar when made by either a semi-works or a commercial manufacturing area is used. Adjustments are generally made in a semi-works facility so that the product produced thereby is equivalent to the product made in a commercial facility. These adjustments are known and made by those skilled in the art.

To make a sample of standard material, with the holding tank nitrogen blanket and lightning mixer/agitator in the off position, a 65-gallon holding tank was filled with as-purchased triethylene glycol di-2-ethylhexoate (3GO) plasticizer. Once the tank was filled, the agitator inside the tank was turned on.

To determine how much of each additive was to be added to the tank, calculations were made, so that, based on the standard recipe of 13.8 g Lowinox® 44B25 per gallon of 3GO plasticizer, 897 g Lowinox® 44B25 was added to the tank. Likewise, 1527.5 g Tinuvin® 326 was added (23.5 g Tinuvin® 326 per gallon of 3GO), and 266.5 g Tinuvin® 123 was added (4.1 g Tinuvin® 123 per gallon of 3GO).

To produce the samples containing the desired amount of plasticizer and additives, three one-gallon jugs were obtained, and the following procedure was used. The first jug was placed on a scale which was then tared to zero. Then each of the following additives were added to the jug, zeroing out the scale between each additive addition: 266.5 g Tinuvin® 123, 697 g Lowinox® 44B25, and 400 g of Tinuvin® 326. After each additive was added, roughly one gallon of 3GO was drained out of the holding tank into the jug, using the sample port, and then set aside.

A second jug was then placed on the scale and tared to zero. The following additives were then added to this jug, with the scale tared to zero after each addition: 200 g Lowinox® 44B25, and 500 g Tinuvin® 326. As before, roughly one gallon of 3GO was drained out of the holding tank into the jug via the sample port, and then set aside.

A third jug was then placed on the scale and tared to zero. Then, 627.5 g of Tinuvin® 326 was added to this jug, with the scale tared to zero. As before roughly one gallon of 3GO was drained out of the holding tank into the jug using the sampling port. This jug was then set aside.

Each jug was then individually placed under the mixer, a mixing wand placed into the jug, and the mixer turned on for 45-60 minutes so that the additives were mixed and dissolved into the 3GO. Once the mixing was completed for each jug, the contents of each jug were poured into the contents of the holding tank. Nitrogen flow was initiated so as to provide a nitrogen blanket over the tank's contents. The stirrer was also turned on, so that the mixture was agitated. The agitation continued inside the holding tank for a minimum of 4 hours before the sample was used in any processing and sample formation.

Manufacture of Resin and Extrusion of Film Samples

The polyvinylbutyral flake was extruded using an 83 mm twin screw Werner Pfleiderer machine. After initially softening in the first temperature zone of the extruder, 3GO plasticizer containing dissolved UV stabilizer(s), antioxidant(s) and/or light stabilizers was injected into the extruder along with a separate injection of adhesion control additive(s).

The plasticizer was injected at an amount commensurate with the extrusion feed rate to provide a goal level of 36.5 parts per hundred (pph) in the final film sample. Likewise, the additives in the plasticizer were dissolved to provide concentration levels of from about 0.01 wt % to about 0.5 wt % in the final film depending upon the goal level.

Adhesion additives were dissolved in demineralized water and adjusted to a flow rate corresponding to provide a goal level for the potassium concentration in parts per million as determined with a calibrated x-ray fluorescence spectrometer (Bruker Model AXS). Three different levels were used in the examples provided herein. These levels were 150, 200 and 250 ppm potassium (K), measured by the x-ray fluorescence spectrometer as counts per second on the K line. The levels can also be identified as 150, 200 and 250 xrf.

Magnesium acetate was used to provide a magnesium concentration of 1/10 of the potassium concentration in the final film. The admixed material in the extruder was processed at an extrusion rate of 240 pounds per hour at an extrusion melt temperature of about 215° C., with zone temperatures varying from about 160° C. to about 220° C., depending upon the melting zone of the machine within standard operating conditions.

The melt from the machine was extruded through a 1-meter-width die to a thickness of 0.76 mm±0.03 mm to produce a sheet. The sheet samples thus produced were interleafed on-line with clean polyethylene film, supplied by Pliant Corp., Chippewa Falls, Wis., prior to cutting them for testing.

Test specimens which were prepared according to the above-described procedure were cut into 12 inch×12 inch specimens. The specimens were conditioned by then placing them in an environment room (E-room) for a minimum of 24 hours. The room temperature was held at 72° F.±5° F. (67° F. to 77° F.), and at relative humidity (RH) of 25.8%±1.3% (24.5% to 27.1%). This generally provided about 0.4% moisture to all samples within the room.

Twenty-four hours before testing, pre-cut standard glass lites (PPG Industries, Pittsburgh, Pa.) of a size of 2.5 inch by 6 inch were washed using a demineralized water rinse cycle. This cycle included washing the lites with 50 milliliters sodium phosphate tribasic docecahydrate (technical grade, granular), dissolved in demineralized water. The lites were exposed to 70° C. heat before the wash cycle began, followed by washing them for 13 minutes, and then exposing the lites to 2-70° C. heat before rinsing them twice with demineralized water tap, each lasting 5 minutes. At the end of the cycle, the glass lites were removed and allowed to dry and cool before placing them back in the E-room. The samples were then assembled in the following manner. The film specimens were cut into three 2.5 in by 6 in pieces, and the samples were assembled using a Tin side/Air side/PVB Sheet/Air side/Tin side construction. Two of these samples were used for exposure, and one was kept as a control.

The samples were then pre-pressed to form laminates, by passing them once through nip rollers, baked in a 90° C. oven for 30 minutes, and then passed twice through nip rollers. Generally, the nip roll speed setting was about 5 linear ft/min, and the nip roll opening was about 1.00 mm narrower than the measured laminate thickness to allow compression of the laminate. Once the laminate was compressed it was removed from the nip roller set up.

Then, the samples were air autoclaved at a standard cycle of 135° C./30 min soak. After the completion of the autoclave cycle, the laminates were allowed to rest for 48 hours without exposure to UV, generally in a sealed box stored in a dark room. After resting, the laminates were cleaned with glass cleaner and lint-free cloth. The samples were then measured using the Hunter Lab instrument before any exposure, and the color coordinates (CIELAB coordinates) were recorded.

Two samples were exposed by placing them in a calibrated air oven at 90° C. for 28 days. The samples were positioned in a rack on their edges at an angle of about 90 degrees. The remaining sample (control) was wrapped in brown paper or in boxes to prevent exposure to UV radiation.

After 28 days, the two test samples were removed from the oven, and the one control sample was either unwrapped or unboxed, and subsequently cleaned with glass cleaner and a lint-free cloth.

The laminates were then measured to obtain their CIELAB coordinates (L*, a*, b*) at 10 degrees/D65 using the Hunter Lab Ultrascan Pro. The measurements were taken 1 cm from the laminate edge and at the center of the laminate, and the data recorded. The measurements of the exposed laminates, as well as the control were used to calculate the Delta E values for each set of samples, using the following equation:

ΔE*=\sqrt{(ΔL*)²+(Δa*)²+(Δb*)²}

where L*, a*, and b* represent the three coordinates of 3-D Lab color space or CIELAB. The lightness, L*, represents the darkest black at L*=0, and the brightest white at L*=100. The color channels, a* and b*, will represent true neutral gray values at a*=0 and b*=0. The red/green opponent colors are represented along the a* axis, with green at negative a* values and red at positive a* values. The yellow/blue opponent colors are represented along the b* axis, with blue at negative b* values and yellow at positive b* values.

Once this calculation was performed the 28-day heat exposure testing was complete. Historical or reference samples were wrapped or boxed to prevent additional UV exposure from light.

Samples were made according to a standard recipe (Control) and for the Comparative Examples and Examples described below. Analyses of the materials made by the recipes and processed according to the methods described herein, via analysis of variance analysis (ANOVA). As known to those skilled in the art, ANOVA is a collection of statistical models and their associated procedures (such as “variation” among and between groups) used to analyze the differences among group means. It was used to determine which additives worked best.

Samples were made from all the examples outlined below, and their Delta E values obtained according to the description above. Each sample's Delta E was measured twice at the edge and these values were then averaged. Each measurement was done at 150 ppm, 200 ppm and 250 ppm K. The Delta E for each control sample was also measured once at each of the ppm values (150, 200, 250).

Control and Experimental Formulations

Control samples were made according to the standard procedure outlined above, with the following ingredients and amounts:

Control 1 13.8 g Lowinox®44B25/gallon
23.5 g Tinuvin®326/gallon
4.1 g Tinuvin®123/gallon

Control 2 was the same formulation as Control 1, except that the potassium adhesion control agent was omitted (magnesium only).

Materials as specified in Table 1 below were made into Control, Experimental and Comparative formulation samples, and tested according to the procedures outlined above. Each example was measured against its paired Control.

For each set, one control sample was analyzed, and two experimental samples were analyzed, with the average Delta E reported in Tables 2-5.

TABLE 1

| | Tinuvin ® | Thanox ® | Tinuvin ® | Tinuvin ® | Lowinox ® | Adhesion |
|---|---|---|---|---|---|---|
| | 622 | 622 | 326 | 123 | 44B25 | Control |
| Example | g/gal | g/gal | g/gal | g/gal | g/gal | Agent |
| Control 1 | — | — | 4.1 | 23.5 | 13.8 | K + Mg |
| C1-1 | 4.2 | — | 23.5 | 4.1 | — | K + Mg |
| C1-2 | 14.1 | — | 23.5 | 4.1 | — | K + Mg |
| C1-3 | 14.2 | — | 23.5 | 4.1 | 4.2 | K + Mg |
| C1-4 | 14.1 | — | 23.5 | 4.1 | 7.1 | K + Mg |
| C1-5 | 14.1 | — | 23.5 | 4.1 | 13.8 | K + Mg |
| C2-1 | — | 9.9 | 23.5 | 4.1 | — | K + Mg |
| C2-2 | — | 9.9 | 23.5 | — | 13.8 | K + Mg |
| E3-1 | 9.9 | — | 23.5 | — | — | K + Mg |
| C3-1 | 9.9 | — | 23.5 | — | 4.2 | K + Mg |
| C3-2 | 9.9 | — | 23.5 | — | 7.1 | K + Mg |
| Control 2 | — | — | 4.1 | 23.5 | 13.8 | Mg |
| E4-1 | 9.9 | — | 23.5 | — | — | Mg |
| C4-1 | 9.9 | — | 23.5 | — | 13.8 | Mg |

TABLE 2

| | | Control 1: C1-1 | Control 1: C1-2 | Control 1: C1-3 |
|---|---|---|---|---|
| ppm | ppm | Edge Delta E | Edge Delta E | Edge Delta E |
| Mg | K | (Std-Ctrl) | (Std-Ctrl) | (Std-Ctrl) |
| 15 | 150 | 1.828 | 2.404 | 1.150 |
| 20 | 200 | 2.410 | 2.774 | 1.500 |
| 25 | 250 | 2.593 | 2.839 | 1.674 |

| | | Comp. Example | Comp. Example | Comp. Example |
|---|---|---|---|---|
| | | 1-1 (C1-1) | 1-2 (C1-2) | 1-3 (C1-3) |
| ppm | ppm | Edge Delta E | Edge Delta E | Edge Delta E |
| Mg | K | (Std-Ctrl) | (Std-Ctrl) | (Std-Ctrl) |
| 15 | 150 | 2.831 | 2.644 | 1.953 |
| 20 | 200 | 3.100 | 3.122 | 1.837 |
| 25 | 250 | 5.014 | 3.493 | 2.346 |

| | | Control 1: C1-4 | Control 1: C1-5 |
|---|---|---|---|
| ppm | ppm | Edge Delta E | Edge Delta E |
| Mg | K | (Std-Ctrl) | (Std-Ctrl) |
| 15 | 150 | 2.067 | 1.801 |
| 20 | 200 | 2.478 | 1.973 |
| 25 | 250 | 2.500 | 2.536 |

| | | Comp. Example | Comp. Example |
|---|---|---|---|
| | | 1-4 (C1-4) | 1-5 (C1-5) |
| ppm | ppm | Edge Delta E | Edge Delta E |
| Mg | K | (Std-Ctrl) | (Std-Ctrl) |
| 15 | 150 | 2.094 | 2.289 |
| 20 | 200 | 2.429 | 2.483 |
| 25 | 250 | 2.844 | 2.790 |

TABLE 3

| ppm | ppm | Control 1: C2-1 | Control 1: C2-2 |
|---|---|---|---|
| Mg | K | Edge Delta E (Std-Ctrl) | Edge Delta E (Std-Ctrl) |
| 15 | 150 | 2.151 | 2.461 |
| 20 | 200 | 2.177 | 2.861 |
| 25 | 250 | 2.416 | 2.794 |
| | | Comp. Example 2-1 | Comp. Example 2-2 |
| ppm | ppm | (C2-1) | (C2-2) |
| Mg | K | Edge Delta E (Std-Ctrl) | Edge Delta E (Std-Ctrl) |
| 15 | 150 | 1.653 | 4.193 |
| 20 | 200 | 2.147 | 3.641 |
| 25 | 250 | 1.98 | 3.18 |

TABLE 4

| | | Control 1: E3-1 | Control 1: C3-1 | Control 1: C3-2 |
|---|---|---|---|---|
| ppm | ppm | Edge Delta E | Edge Delta E | Edge Delta E |
| Mg | K | (Std-Ctrl) | (Std-Ctrl) | (Std-Ctrl) |
| 15 | 150 | 1.913 | 2.043 | 1.381 |
| 20 | 200 | 2.5 | 2.453 | 2.299 |
| 25 | 250 | 2.413 | 2.821 | 2.932 |

| | | Example | Comp. Example | Comp. Example |
|---|---|---|---|---|
| | | 3-1 (E3-1) | 3-1 (C3-1) | 3-2 (C3-2) |
| ppm | ppm | Edge Delta E | Edge Delta E | Edge Delta E |
| Mg | K | (Std-Ctrl) | (Std-Ctrl) | (Std-Ctrl) |
| 15 | 150 | 1.514 | 2.468 | 2.685 |
| 20 | 200 | 0.909 | 3.146 | 3.227 |
| 25 | 250 | 0.887 | 2.793 | 3.908 |

TABLE 5

| ppm | ppm | Control 2: E4-1 | Control 2: C4-1 |
|---|---|---|---|
| K | Mg | Edge Delta E (Std-Ctrl) | Edge Delta E (Std-Ctrl) |
| — | 15 | 1.99 | 1.751 |
| — | 20 | 1.503 | 2.787 |
| — | 25 | 0.88 | 3.101 |
| | | Example 4-1 | Comp. Example 4-1 |
| ppm | ppm | (E4-1) | (C4-1) |
| K | Mg | Edge Delta E (Std-Ctrl) | Edge Delta E (Std-Ctrl) |
| — | 15 | 0.497 | 1.954 |
| — | 20 | 0.632 | 1.784 |
| — | 25 | 0.614 | 1.387 |

The data obtained and presented in Tables 2-5 above were then analyzed to ascertain the percent decrease in yellowness of the samples. The delta E values at each of the three ppm levels were averaged, and then the percent decrease in yellowness, measured by delta E, was calculated. These data appear in Table 6 below.

TABLE 6

| | Edge | | | |
|---|---|---|---|---|
| | Avg | % | Adhesion | |
| | Delta | De- | Control | |
| Ex No. | E | crease | Agent | Note |
| Control 1 | 2.277 | | K + Mg | |
| C1-1 | 3.648 | −60.2 | K + Mg | Oligomeric HALS + Second |
| | | | | HALS |
| Control 1 | 2.672 | | K + Mg | |
| C1-2 | 3.086 | −15.5 | K + Mg | Oligomeric HALS + Second |
| | | | | HALS |
| Control 1 | 1.441 | | K + Mg | |
| C1-3 | 2.045 | −41.9 | K + Mg | Oligomeric HALS + Second |
| | | | | HALS + AO |
| Control 1 | 2.348 | | K + Mg | |
| C1-4 | 2.456 | −4.6 | K + Mg | Oligomeric HALS + Second |
| | | | | HALS + AO |
| Control 1 | 2.103 | | K + Mg | |
| C1-5 | 2.521 | −19.9 | K + Mg | Oligomeric HALS + Second |
| | | | | HALS + AO |
| Control 1 | 2.248 | | K + Mg | |
| C2-1 | 1.927 | 14.3 | K + Mg | Oligomeric HALS + Second |
| | | | | HALS |
| Control 1 | 2.705 | | K + Mg | |
| C2-2 | 3.671 | −35.7 | K + Mg | Oligomeric HALS + AO |
| Control 1 | 2.275 | | K + Mg | |
| E3-1 | 1.103 | 51.5 | K + Mg | Oligomeric HALS Only |
| | | | | (Inventive) |
| Control 1 | 2.439 | | K + Mg | |
| C3-1 | 2.802 | −14.9 | K + Mg | Oligomeric HALS + AO |
| Control 1 | 2.204 | | K + Mg | |
| C3-2 | 3.273 | −48.5 | K + Mg | Oligomeric HALS + AO |
| Control 2 | 1.458 | | Mg | |
| E4-1 | 0.581 | 60.1 | Mg | Oligomeric HALS Only |
| | | | | (Inventive) |
| Control 2 | 2.546 | | Mg | |
| C4-1 | 1.708 | 32.9 | Mg | Oligomeric HALS + AO |

As can be seen for the data, the best results were obtained when, in accordance with the present invention, only the olgomeric HALS was used without added antioxidant and/or other HAL S.

The data also indicated that higher potassium was related to poorer yellowing performance and higher all magnesium adhesion control package was positive for lower edge discoloration.

### Comparative Examples C5-1, C5-2 and C5-3, and Examples E5-1, E5-2 and E5-3

Comparative example samples were made according to the standard procedure outlined above. Three different samples were made, with 150, 200 and 250 ppm potassium, respectively, for each comparative example. The following ingredients and amounts were used in each example:

### COMPARATIVE EXAMPLES

13.8 g Lowinox® 44B25/gal
4.1 g Tinuvin® 123/gal
23.5 g Tinuvin® 326/gal

### EXAMPLES

9.9 g Tinuvin® 622/gal
23.5 g Tinuvin® 326/gal

These comparative and experimental samples were then tested according to EMMA weathering procedures for one- and two-year natural weathering in Florida, using ASTM G7-05 and G147-02. Table 7 includes the average delta E values and the percent decrease in yellowing, for these comparative and experimental samples.

TABLE 7

| ppm | Ex. | 1 Year Avg | 1 Year % | 2 year Avg | 2 Year % |
|---|---|---|---|---|---|
| K | No. | Delta E | Decrease | Delta E | Decrease |
| 150 | C5-1 | 0.34 | | 0.55 | |
| 150 | E5-1 | 0.18 | 47.10 | 0.25 | 54.50 |
| 200 | C5-2 | 0.41 | | 0.45 | |
| 200 | E5-2 | 0.17 | 58.50 | 0.13 | 71.10 |
| 250 | C5-3 | 0.64 | | 0.46 | |
| 250 | E5-3 | 0.61 | 4.70 | 0.10 | 78.00 |

As can be seen from the results, one- and two-year weathering data (via EMMA testing as described above) confirmed that including only an olgomeric HALS in amounts of 0.03%-0.20%, and in the substantial absence of other HALS and no added antioxidants, led to a decrease in edge yellowing as measured by delta E, at levels of 4% or greater.

What is claimed is:

1. A plasticized polyvinylacetal composition comprising (a) a polyvinylacetal resin having a hydroxyl number of from about 12 to about 34; (b) a plasticizer in an amount of about 60 parts per hundred (pph) or less based on the dry weight of the polyvinylacetal resin; and (c) a light stabilizer/antioxidant additive package comprising an oligomeric hindered amine light stabilizer with antioxidant functionality (oligomeric HALS), wherein substantially no additional antioxidant or hindered amine light stabilizer is present in the plasticized polyvinylacetal composition.

2. The plasticized polyvinylacetal composition of claim 1, wherein the polyvinylacetal is polyvinylbutyral.

3. The plasticized polyvinylacetal composition of claim 1, wherein the plasticizer is selected from the group consisting of triethyleneglycol di-(2-ethyl hexanoate) (3GO), dibutyl sebacate (DBS), dihexyl adipate (DHA), tetraethylene glycol di(2-heptanoate) (4G7) and mixtures thereof.

4. The plasticized polyvinylacetal composition of claim 1, wherein the plasticizer is triethyleneglycol di-(2-ethyl hexanoate) (3GO).

5. The plasticized polyvinylacetal composition of claim 1, wherein the oligomeric HALS is butanedioic acid, dimethylester, polymer with 4-hydroxy-2,2,6,6,-tetramethyl-1-piperidine ethanol.

6. The plasticized polyvinylacetal composition of claim 1, wherein the amount of oligomeric HALS is from about 0.03 to about 0.2 weight percent based on the total weight of the composition.

7. The plasticized polyvinylacetal composition of claim 1, wherein the light stabilizer/antioxidant additive package consists essentially of an oligomeric HALS and optionally a UV absorber.

8. The plasticized polyvinylacetal composition of claim 1, wherein the light/stabilizer/antioxidant package consists of an oligomeric HALS and optionally a UV absorber.

9. The plasticized polyvinylacetal composition of claim 1, wherein the composition further comprises an adhesion control agent.

10. The plasticized polyvinylacetal composition of claim 9, wherein the adhesion control agent is one or more alkali metal salts and/or alkaline earth metal salts.

11. The plasticized polyvinylacetal composition of claim 10, wherein the adhesion control agent is a potassium salt, a magnesium salt or a mixture thereof.

12. The plasticized polyvinylacetal composition of claim 11, wherein the adhesion control agent is a magnesium salt.

13. The plasticized polyvinylacetal composition of claim 1, wherein the composition further comprises a UV absorber.

14. The plasticized polyvinylacetal composition of claim 1, wherein the plasticizer is selected from the group consisting of triethyleneglycol di-(2-ethyl hexanoate) (3GO), dibutyl sebacate (DBS), dihexyl adipate (DHA), tetraethylene glycol di(2-heptanoate) (4G7) and mixtures thereof; the amount of oligomeric HALS is from about 0.03 to about 0.2 weight percent based on the total weight of the composition; and the composition further comprises an adhesion control agent.

15. The plasticized polyvinylacetal composition of claim 14, wherein the light stabilizer/antioxidant additive package consists essentially of an oligomeric HALS and optionally a UV absorber.

16. A monolayer film or sheet comprising a plasticized polyvinylacetal composition comprising (a) a polyvinylacetal resin having a hydroxyl number of from about 12 to about 34; (b) a plasticizer in an amount of about 60 parts per hundred (pph) or less based on the dry weight of the polyvinylacetal resin; and (c) a light stabilizer/antioxidant additive package comprising an oligomeric hindered amine light stabilizer with antioxidant functionality (oligomeric HALS), wherein substantially no additional antioxidant or hindered amine light stabilizer is present in the plasticized polyvinylacetal composition.

17. A multilayer sheet comprising at least one monolayer film or sheet as set forth in claim 16.
